(19) United States
(12) Patent Application Publication
(10) Pub. No.: US 2015/0078805 A1
(43) Pub. Date: Mar. 19, 2015

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventors: Steven E. Morris, Fair Haven, MI (US); Joel Colombo, Howell, MI (US); Jennifer P. Lawall, Waterford, MI (US); Jeffrey L. Konchan, Romeo, MI (US); Steve J. Briggs, Harrison Township, MI (US)

(73) Assignee: GM GLOBAL TECHNOLOGY OPERATIONS LLC, Detroit, MI (US)

(21) Appl. No.: 14/031,647

(22) Filed: Sep. 19, 2013

(51) Int. Cl. B62D 27/04; B62D 27/06

(52) U.S. Cl. CPC B62D 27/04; B62D 27/06
USPC 403/13

(57) ABSTRACT

In one aspect, an elastically averaged alignment system is provided. The system includes a first component including an alignment member, the alignment member including a plurality of segments. The system also includes a second component including an inner wall defining an alignment aperture, the alignment aperture configured to receive the alignment member to couple the first component and the second component. The alignment member is an elastically deformable material such that when the alignment member is inserted into the alignment aperture, the alignment member elastically deforms to an elastically averaged final configuration to facilitate aligning the first component and the second component in a desired orientation.

### FIELD OF THE INVENTION

The subject invention relates to matable components and, more specifically, to elastically averaged matable components for alignment and retention.

### BACKGROUND

Components, in particular vehicular components which are to be mated together in a manufacturing process, may be mutually located with respect to each other by alignment features that are oversized holes and/or undersized upstanding bosses. Such alignment features are typically sized to provide spacing to freely move the components relative to one another to align them without creating an interference therebetween that would hinder the manufacturing process. One such example includes two-way and/or four-way male alignment features; typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignment may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling, and further result in the perception of poor quality.

Additionally, some components, particularly components made of compliant materials, may not remain mated to another component due to vehicle movement, passage of time, or other factors. As such, the male alignment features may become disengaged from corresponding female alignment features leading to additional noise, vibration, or reduced durability.

### SUMMARY OF THE INVENTION

In one aspect, an elastically averaged alignment system is provided. The system includes a first component including an alignment member, the alignment member including a plurality of segments. The system also includes a second component including an inner wall defining an alignment aperture, the alignment aperture configured to receive the alignment member to couple the first component and the second component. The alignment member is an elastically deformable material such that when the alignment member is inserted into the alignment aperture, the alignment member elastically deforms to an elastically averaged final configuration to facilitate aligning the first component and the second component in a desired orientation.

In another aspect, a vehicle is provided. The vehicle includes a body and an elastically averaged alignment system integrally arranged with the body. The elastically averaged alignment system includes a first component including an alignment member, the alignment member including a plurality of segments. The system also includes a second component including an inner wall defining an alignment aperture, the alignment aperture configured to receive the alignment member to couple the first component and the second component. The alignment member is an elastically deformable material such that when the alignment member is inserted into the alignment aperture, the alignment member elastically deforms to an elastically averaged final configuration to facilitate aligning the first component and the second component in a desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of a disassembled, exemplary elastically averaged alignment system;

FIG. 2 is a cross-sectional view of the disassembled elastically averaged alignment system shown in FIG. 1;

FIG. 3 is a perspective view of an exemplary alignment member and retention feature that may be used with the system shown in FIGS. 1 and 2;

FIG. 4 is perspective view of another exemplary alignment member and retention feature that may be used with the system shown in FIGS. 1 and 2;

FIG. 5 is a perspective view of yet another exemplary alignment member and retention feature that may be used with the system shown in FIGS. 1 and 2;

FIG. 6 is a perspective view of yet another exemplary alignment member that may be used with the system shown in FIGS. 1 and 2;

FIG. 7 is a perspective view of another disassembled, exemplary elastically averaged alignment system;

FIG. 8 is a cross-sectional view of the system shown in FIG. 7 and after assembly;

FIG. 9 is a cross-sectional view of the system shown in FIG. 8 and taken along line 9-9; and

FIG. 10 is a perspective view of the system shown in FIGS. 8 and 9.

### DETAILED DESCRIPTION

The following description is merely exemplary in nature and is not intended to limit the present disclosure, its application or uses. For example, the embodiments shown are applicable to vehicle body panels, but the alignment system disclosed herein may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=S/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are alignment and retention systems, as well as methods for elastically averaged mating assemblies. The alignment and retention systems include retention member(s) that facilitate preventing unintentional disassembly of the elastically averaged mated assemblies, yet allow purposeful disassembly if desired. As such, the alignment and retention systems prevent accidental or premature separation of mated components, thereby maintaining a proper coupling between and desired orientation of two or more components.

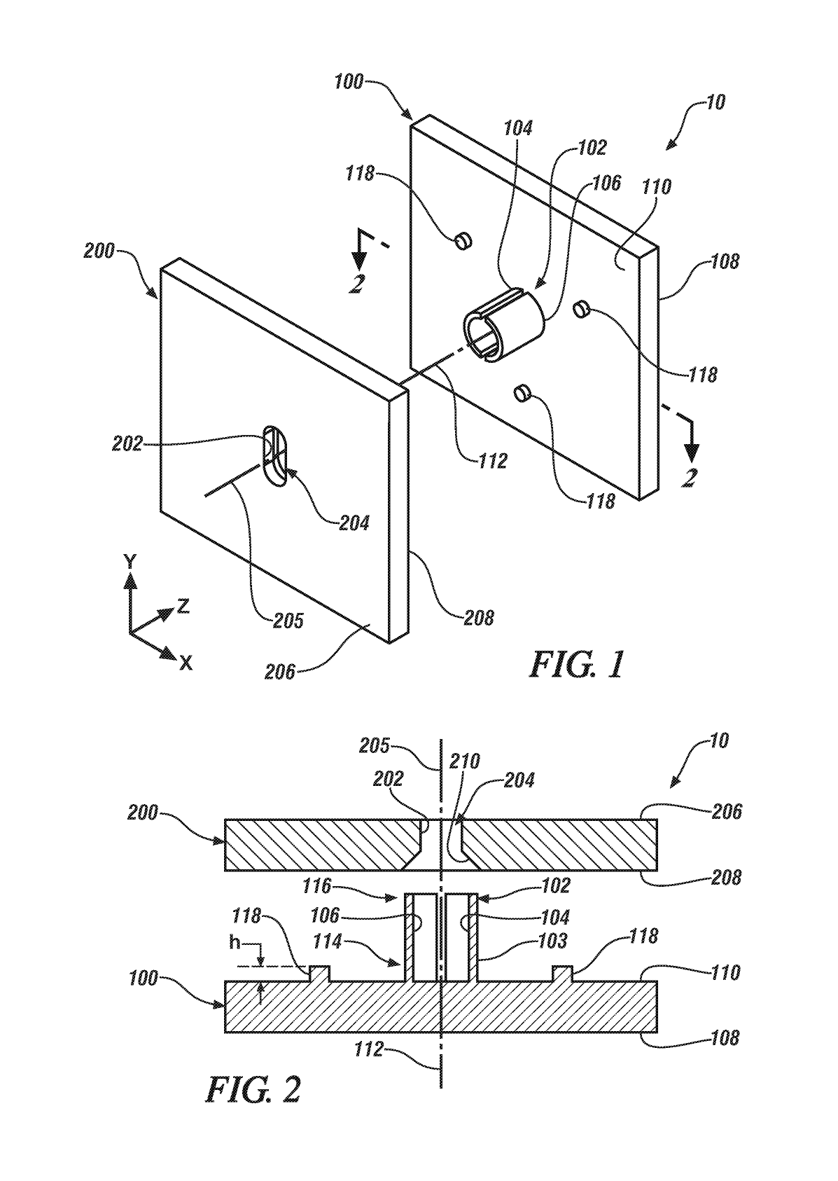

FIGS. 1 and 2 illustrate an exemplary elastically averaged alignment system 10 that generally includes a first component 100 to be mated to a second component 200. First component 100 includes an elastically deformable alignment member 102 that includes a first segment 104 and a second segment 106, and second component 200 includes an inner wall 202 defining an alignment aperture 204. In the exemplary embodiment, segments 104, 106 are substantially semi-circular to define a generally circular alignment member 102. Alternatively, segments 104, 106 may have any suitable shape. Moreover, alignment member 102 may have any suitable number of segments; for example, three segments or four segments (see FIG. 5). Alignment member 102 and alignment aperture 204 are fixedly disposed on or formed integrally with their respective component 100, 200 for proper alignment and orientation when components 100 and 200 are mated. Although a single alignment member 102 and alignment aperture 204 are illustrated, components 100 and 200 may have any number and combination of corresponding alignment members 102 and alignment apertures 204. Elastically deformable alignment member 102 is configured and disposed to interferingly, deformably, and matingly engage alignment aperture 204, as discussed herein in more detail, to precisely align first component 100 with second component 200 in two or four directions, such as the +/−x-direction and the +/−y-direction of an orthogonal coordinate system, for example, which is herein referred to as two-way and four-way alignment. Moreover, elastically deformable alignment member 102 matingly engages alignment aperture 204 to facilitate a stiff and rigid connection between first component 100 and second component 200, thereby reducing or preventing relative movement therebetween.

In the exemplary embodiment, first component 100 generally includes an outer face 108 and an inner face 110 from which alignment member 102 extends. Alignment member 102 is a generally circular, hollow shape having a central axis 112, a proximal end 114 coupled to inner face 110, and a distal end 116. However, alignment member 102 may have any cross-sectional shape that enables system 10 to function as described herein. First component 100 may optionally include one or more stand-offs 118 (FIGS. 1 and 2) for engaging and supporting second component 200. In the exemplary embodiment, first component 100 is fabricated from a rigid material such as plastic. However, first component 100 may be fabricated from any suitable material that enables system 10 to function as described herein.

Second component 200 generally includes an outer face 206 and an inner face 208. In the exemplary embodiment, alignment aperture 204 is illustrated as an elongated slot (e.g., similar to the shape of elastic tube alignment system described in co-pending U.S. patent application Ser. No. 13/187,675 and particularly illustrated in FIG. 13 of the same). Alternatively, alignment aperture 204 may have any suitable shape that enables system 10 to function as described herein. For example, alignment aperture 204 may have a generally circular cross-section, which may be particularly suited for mating with a multi-segmented alignment member 102 as shown in FIG. 5. In the exemplary embodiment, second component 200 is fabricated from a rigid material such as sheet metal. However, second component 200 may be fabricated from any suitable material that enables system 10 to function as described herein.

Moreover, inner wall 202 may be elastically deformable to facilitate added elastic average tuning of system 10. For example, inner wall 202 and/or a surrounding portion of second component 200 may be made from an elastically deformable material and/or have a smaller thickness or sheet metal gauge than the rest of component 200. As such, during insertion of alignment member 102 into alignment aperture 204, inner wall 202 and/or a surrounding portion of component 200 elastically deforms to an elastically averaged final configuration to facilitate aligning first component 100 and second component 200 in a desired orientation. Accordingly, first component tube thickness and second component material and/or gauge may be adjusted to tune the elastic average mating between first component 100 and second component 200.

While not being limited to any particular structure, first component 100 may be a decorative trim component of a vehicle with the customer-visible side being outer face 108, and second component 200 may be a supporting substructure that is part of, or is attached to, the vehicle and on which first component 100 is fixedly mounted in precise alignment.

To provide an arrangement where elastically deformable alignment member 102 is configured and disposed to interferingly, deformably and matingly engage inner wall 202 of alignment aperture 204, the diameter of at least a portion of alignment aperture 204 is less than the diameter of alignment member 102, which necessarily creates a purposeful interference fit between the elastically deformable alignment member 102 and alignment aperture 204. Further, second component 200 may include a chamfer 210 to facilitate insertion of alignment member 102. As such, when inserted into slotted alignment aperture 204, portions of the elastically deformable alignment member 102 elastically deform to an elastically averaged final configuration that aligns alignment member 102 with the alignment aperture 204 in two planar orthogonal directions (the +/−x-direction or the +/−y-direction. Where alignment aperture 204 is generally circular, alignment member 102 is aligned in four planar orthogonal directions (the +/−x-direction and the +/−y-direction).

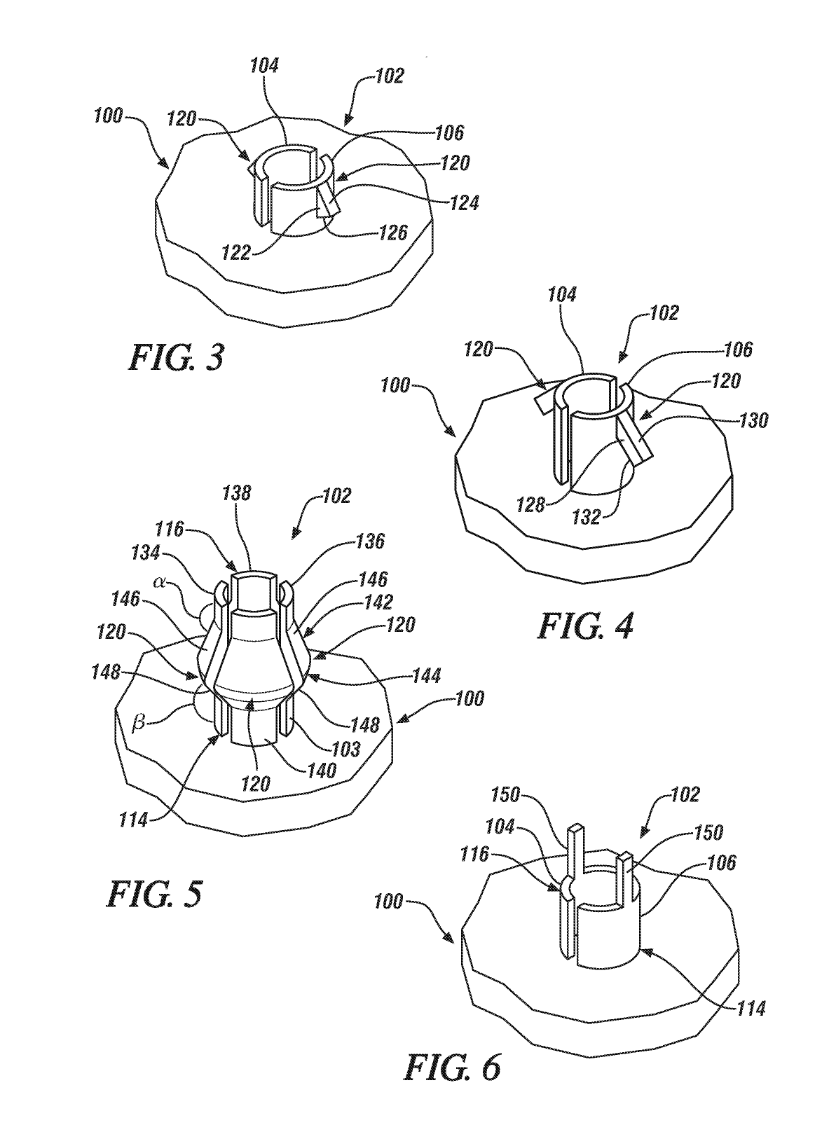

As shown in FIGS. 3 and 4, alignment member 102 may include a retention member 120 that facilitates retention of alignment member 102 within alignment aperture 204. In the exemplary embodiment of FIG. 3, retention member 120 includes a substantially triangular body 122 having an insertion face 124 and a retention face 126. Angled insertion face 124 facilitates ease of insertion of alignment member 102 into alignment aperture 204, and after insertion, retention face 126 engages outer face 206 to facilitate preventing alignment member 102 from backing out of alignment aperture 204. In the exemplary embodiment of FIG. 4, retention member 120 includes a barb-shaped body 128 having an insertion face 130 and a retention face 132. Similarly, angled insertion face 130 facilitates insertion of alignment member 102 and retention face 132 facilitates preventing removal of alignment member 102 from alignment aperture 204.

FIG. 5 illustrates another exemplary embodiment of elastically deformable alignment member 102, which includes four segments 134, 136, 138, and 140. Segments 134 and 136 are opposed and segments 138 and 140 are opposed to define a substantially circular-shaped alignment member 102. Each segment 134, 136, 138, and 140 may have a retention member 120 that includes a first angled portion 142 and a second angled portion 144 each extending angularly from alignment member distal end 116. First angled portion 142 defines an insertion face 146 configured to engage inner wall 202 and/or chamfer 210 during insertion of alignment member 102 within alignment aperture 204. In the exemplary embodiment, insertion face 146 extends from an alignment member outer wall 103 at an angle “a”, which may be variably designed such that a predetermined force will be required to insert alignment member 102. For example, as angle “a” is increased, the force required for alignment member insertion is reduced, and vice versa. Similarly, second angled portion 144 defines a retention face 148 configured to engage outer surface 206 and/or inner wall 202 following insertion and during removal of alignment member 102 from within alignment aperture 204. In the exemplary embodiment, retention face 148 extends from alignment member outer wall 103 at an angle “β”, which is variably designed such that a predetermined force will be required to remove alignment member 102 from alignment aperture 204. For example, as angle “β” is increased, the force requirement for alignment member removal is reduced, and vice versa. In the exemplary embodiment, angle “β” is less than angle “a” such that the force required for alignment member removal is greater than the force required for alignment member insertion. This facilitates ease of assembly, but removal requires a purposeful force (i.e., forces larger than experienced during typical vehicle use).

As shown in FIGS. 3-5, each segment 104, 106, 134, 136, 138 and 140 includes a single retention member 120. However, each segment may include any number of retention members 120 that enables system 10 to function as described herein. Moreover, retention members 120 may be positioned in any desired location along outer wall 103 between proximal end 114 and distal end 116, or may comprise the entire length of outer wall 103 therebetween.

FIG. 6 illustrates another exemplary embodiment of elastically deformable alignment member 102 that includes a pair of removal tabs 150. Each removal tab 150 extends from distal end 116 of first segment 104 and second segment 106. Removal tabs 150 facilitate removal of alignment member 102 from alignment aperture 204 such that tabs 150 may be biased toward one another, thereby biasing elastically deformable segments 104 and 106 toward each other. Accordingly, segments 104 and 106 are biased away from and at least partially out of contact with inner wall 202 such that alignment member 102 may then be removed from within alignment aperture 204. Although not shown, the alignment member of FIG. 6 may also include a retention feature 120 as shown in FIGS. 3-5.

While FIGS. 1 and 2 depict a single elastically deformable alignment member 102 in a corresponding slotted aperture 204 to provide two-way alignment of the first component 100 relative to the second component 200, it will be appreciated that the scope of the invention is not so limited and encompasses other quantities and types of elastically deformable alignment elements used in conjunction with the elastically deformable alignment member 102 and corresponding circular aperture 204.

With further reference to FIGS. 1 and 2, standoffs 118 may be spaced relative to the outer diameter of alignment aperture 204 such that they provide a support platform at a height “h” above first component inner face 110. Second component inner face 208 rests upon standoffs 118 when elastically deformable alignment member 102 is inserted into alignment aperture 204. Stated alternatively, standoffs 118 are disposed and configured to provide a final positional orientation between alignment aperture 204 and elastically deformable alignment element 102 at an elevation “h” above the base, inner face 110, of elastically deformable alignment member 102. While FIG. 1 depicts three standoffs 118 in the form of posts at a height “h” relative to first component inner face 110, it will be appreciated that the scope of the invention is not so limited and also encompasses other numbers and shapes of standoffs 118 suitable for a purpose disclosed herein, and also encompasses a standoff in the form of a continuous ring disposed around alignment member 102. All such alternative standoff arrangements are contemplated and considered within the scope of the invention disclosed herein. Moreover, while FIGS. 1 and 2 depict standoffs 118 integrally formed on inner face 110, it will be appreciated that a similar function may be achieved by integrally forming standoffs 118 on second component inner face 208, which is herein contemplated and considered to be within the scope of the invention disclosed herein. Alternatively, system 10 may not include standoffs.

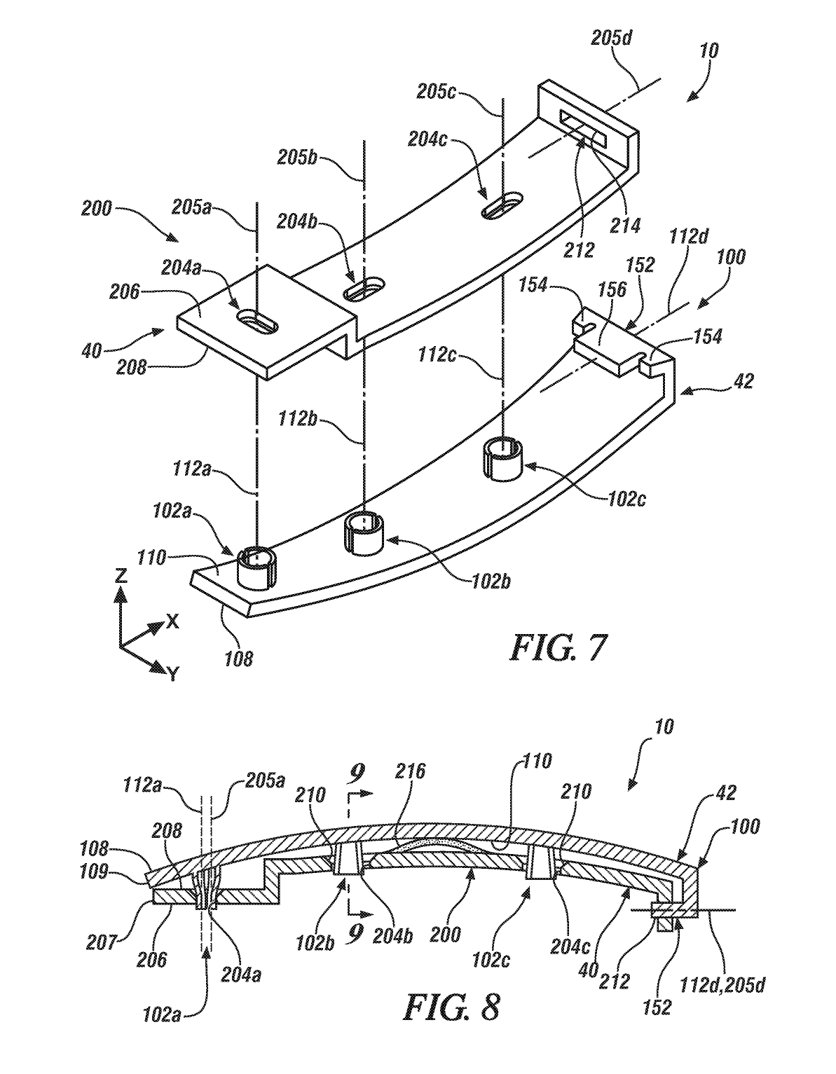

In view of the foregoing, and with reference now to FIGS. 7-10, it will be appreciated that an exemplary embodiment of the invention includes elastically averaging alignment system 10 implemented in a vehicle (not shown). For example, second component 200 may be a vehicle body door handle 40 configured to receive first component 100, which may be a door handle insert 42. However, it is contemplated that an elastically averaging alignment system 10 as herein disclosed may be utilized with other features of the vehicle, such as exterior body trim, interior trim, inserts, bezels, or decorative trim.

As shown in FIGS. 7-9, insert 42 includes a plurality of alignment members 102a, 102b, 102c, and door handle 40 includes a plurality of corresponding alignment apertures 204a, 204b, 204c. Elastically deformable alignment members 102a, 102b, 102c facilitate elastic averaging over the total of alignment members 102 to facilitate substantially aligning centerlines 112a, 112b, 112c with centerlines 205a, 205b, and 205c of corresponding alignment apertures 204a, 204b, 204c, and leading to an improved coupling between first component 100 and second component 200. Although not shown, each of alignment members 102a, 102b, 102c may include one or more retention features 120 as described herein.

In the exemplary embodiment, insert 42 also includes an elastically deformable alignment wedge 152 having two end segments 154 and a middle segment 156. Door handle 40 includes a corresponding alignment wedge aperture 212 defined by an inner wall 214. Elastically deformable alignment wedge 152 is configured and disposed to interferingly, deformably, and matingly engage inner wall 214 of alignment wedge aperture 212, to precisely align insert 42 with door handle 40 in two or four directions, such as the +/−z-direction and the +/−y-direction of an orthogonal coordinate system. As such, when inserted into alignment wedge aperture 212, end segments 154 deform towards middle segment 156 to align insert 42 and door handle 40. Moreover, elastically deformable alignment wedge 152 matingly engages alignment wedge aperture 212 to facilitate a stiff and rigid connection between door handle 40 and insert 42, thereby reducing or preventing relative movement therebetween. Although a single alignment wedge 152 is illustrated, system 10 may have any suitable number of alignment wedges 152 and corresponding alignment wedge apertures 212.

Door handle 40 may also include a biasing member 216 coupled to inner face 208 and that seats against inner face 110 when door handle insert 42 is coupled to door handle 40. Biasing member 216 is biased into contact with inner face 110 to facilitate preventing rattling between door handle 40 and insert 42 when the vehicle is in motion. For example, biasing member 216 may be a spring or the like. Although biasing member 216 is illustrated as coupled to second component 200, a biasing member may also be coupled to first component 100.

As shown in FIG. 8, alignment member 102a is positioned on the end of first component 100 to precisely align and orient an end 109 of first component 100 with an end 207 of second component 200. As such, alignment member 102a elastically deforms within alignment aperture 204a such that first and second segments 104 and 106, FIGS. 1-6, are deflected toward each other to align centerline 112a substantially with centerline 205a of aperture 204a for alignment substantially in the +/−x direction. It should also be understood that alignment member 102a will have clearance to alignment aperture 204a in the +/−y direction. Due, for example, to the inherent manufacturing tolerance and variance of oversized alignment apertures 204a-c, such apertures 204a-c may be formed in a location other than the exact design location. Alignment members 102b and 102c elastically deform within respective alignment apertures 204b and 204c substantially in the +/−y direction. As shown in this embodiment, as an example, the left and right portions of alignment members 102b, 102c do not contact the left or right end of slot apertures 204b, 204c due to the length of slotted apertures in the +/−x direction.

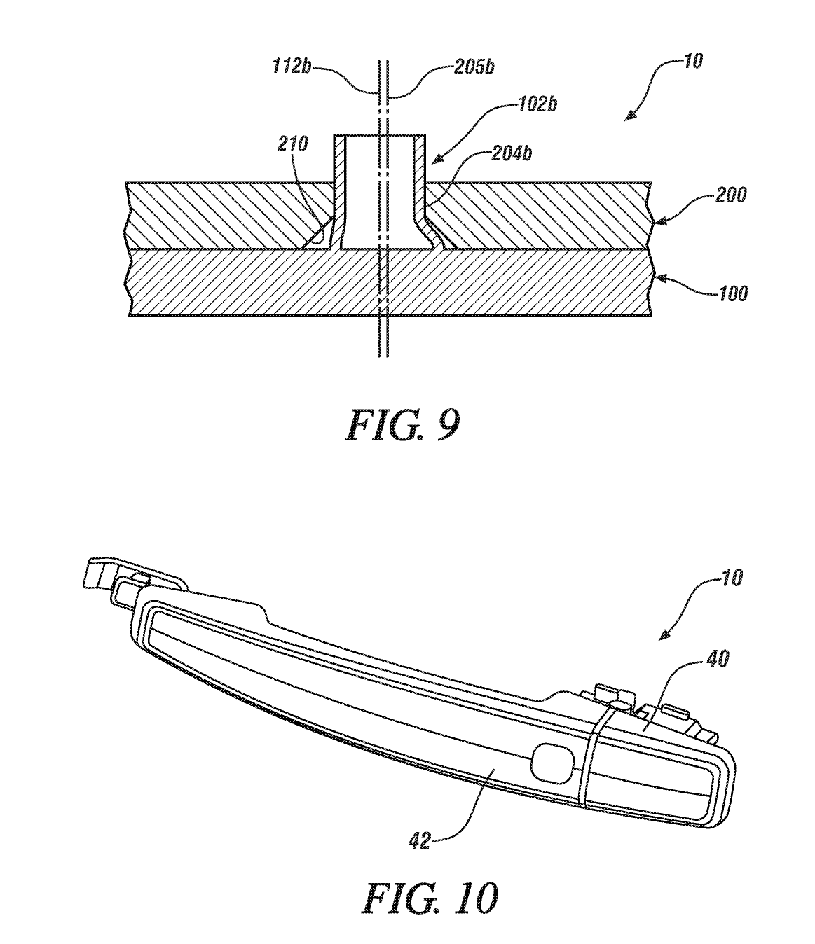

As shown in FIG. 9, alignment member 102b elastically deforms within respective alignment aperture 204b to facilitate bringing centerline 112b more in-line with centerline 205b of alignment aperture 204b. As an example, due to manufacturing variances, the right portion of member 102b deforms more than the left portion of alignment member 102b to elastically average the member positioning and substantially align the centerlines such that centerline 112b is only slightly off-set from centerline 205b of respective alignment aperture 204b. Although not shown, alignment member 102c behaves in a manner similar to alignment member 102b. However, it should be understood that any combination of deformation to alignment members 102 may occur due to the variance between mating parts 100, 200.

Accordingly, alignment members 102a, 102b, and 102c elastically average the alignment features of first and second components 100, 200 to couple them in a desired orientation. Additionally, alignment wedge 152 elastically deforms within alignment wedge aperture 212 such that end segments 154 are deflected toward middle segment 156 and a wedge centerline 112d. Accordingly, alignment wedge 152 elastically deforms to facilitate aligning centerline 112d substantially with a centerline 205d of aperture 212 to align and couple first and second components 100 and 200 in a desired orientation.

Elastically averaged mating assembly systems are described herein. The systems generally include a first component with an elastically deformable alignment member positioned for insertion into an alignment aperture of a second component. The mating of the first and second components is elastically averaged over a corresponding pair or pairs of elastically deformable alignment members and alignment apertures to precisely mate the components in a desired orientation. The systems may include a retention member for self-retention of the alignment member within the alignment aperture, and a biasing member for preventing rattling between the first and second components. Further, the retention features facilitate preventing unintentional disassembly of elastically averaged mated components, tunable elastically averaged mating systems, and reducing or eliminating the need for fasteners to mate the components.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising an alignment member, said alignment member including a plurality of segments;
a second component comprising an inner wall defining an alignment aperture, said alignment aperture configured to receive said alignment member to couple said first component and said second component,
wherein said alignment member is an elastically deformable material such that when said alignment member is inserted into said alignment aperture, said alignment member elastically deforms to an elastically averaged final configuration to facilitate aligning said first component and said second component in a desired orientation.

2. The system of claim 1, wherein said plurality of segments comprises a pair of opposed semi-circular segments.

3. The system of claim 1, wherein said plurality of segments comprises two pairs of opposed segments.

4. The system of claim 1, wherein said alignment member further comprises at least one retention radially outwardly extending member configured to engage said second component to facilitate retaining at least a portion of said alignment member within said alignment aperture.

5. The system of claim 4, wherein said at least one retention member is at least one of substantially triangular shaped and barb-shaped.

6. The system of claim 4, wherein said at least one retention member comprises a first angled portion defining an insertion face extending from said alignment member at a first angle, and a second angled portion defining a retention face extending from said alignment member at a second angle.

7. The system of claim 1, wherein said first component further comprises an alignment wedge and said second component further comprises a second inner wall defining an alignment wedge aperture, wherein said alignment wedge is an elastically deformable material such that when said alignment wedge is inserted into said alignment wedge aperture, said alignment wedge elastically deforms to an elastically averaged final configuration to facilitate aligning said first component and said second component.

8. The system of claim 1, wherein said second component further comprises a biasing member configured to seat against a portion of said first component.

9. The system of claim 2, wherein each semi-circular segment includes a tab extending therefrom, said tabs configured to facilitate biasing said segments toward one another for removal of said alignment member from said alignment aperture.

10. A vehicle comprising:
a body; and
an elastically averaged alignment system integrally arranged with said body, said elastically averaged alignment system comprising:
a first component comprising an alignment member, said alignment member including a plurality of segments;
a second component comprising an inner wall defining an alignment aperture, said alignment aperture configured to receive said alignment member to couple said first component and said second component,
wherein said alignment member is an elastically deformable material such that when said alignment member is inserted into said alignment aperture, said alignment member elastically deforms to an elastically averaged final configuration to facilitate aligning said first component and said second component in a desired orientation.

11. The vehicle of claim 10, wherein said first component is a door handle insert and said body comprises said second component.

12. The vehicle of claim 10, wherein said plurality of segments comprises a pair of opposed semi-circular segments.

13. The vehicle of claim 10, wherein said plurality of segments comprises a two pairs of opposed segments.

14. The vehicle of claim 10, wherein said alignment member further comprises at least one retention member configured to engage said second component to facilitate retaining at least a portion of said alignment member within said alignment aperture.

15. The vehicle of claim 14, wherein said at least one retention member is at least one of substantially triangular shaped and barb shaped.

16. The vehicle of claim 14, wherein said at least one retention member comprises a first angled portion defining an insertion face extending from said alignment member at a first angle, and a second angled portion defining a retention face extending from said alignment member at a second angle.

17. The vehicle of claim 10, wherein said first component further comprises an alignment wedge and said second component further comprises a second inner wall defining an alignment wedge aperture, wherein said alignment wedge is an elastically deformable material such that when said alignment wedge is inserted into said alignment wedge aperture, said alignment wedge elastically deforms to an elastically averaged final configuration to facilitate aligning said first component and said second component.

18. The vehicle of claim 10, wherein said second component further comprises a biasing member configured to seat against a portion of said first component.

19. The vehicle of claim 12, wherein each semi-circular segment includes a tab extending therefrom, said tabs configured to facilitate biasing said segments toward one another for removal of said alignment member from said alignment aperture.
